(19) United States
(12) Patent Application Publication
(10) Pub. No.: US 2014/0042093 A1
(43) Pub. Date: Feb. 13, 2014

(54) ROTARY VACUUM-DRUM FILTER WITH MEMBRANE FILTER

(71) Applicant: Peter Kristin Silverberg, Southbridge, MA (US)

(72) Inventor: Peter Kristin Silverberg, Southbridge, MA (US)

(21) Appl. No.: 13/817,451

(22) PCT Filed: Jul. 27, 2011
(86) PCT No.: PCT/US11/45608

§ 371 Date: Sep. 27, 2013

Related U.S. Application Data
(60) Provisional application No. 61/368,152, filed on Jul. 27, 2010.
(60) Provisional application No. 61/504,226, filed on Jul. 3, 2011.

(51) Int. Cl. B01D 63/16

(52) U.S. Cl. CPC B01D 63/16
USPC 210/650; 210/321.68

(57) ABSTRACT

A system for separating a penetrant from a feed steam, using a drum filter [10], which includes a drum [20] with a porous drum wall [30], a tank in which the drum is mounted, a feed stream, a semipermeable membrane [50] on the outside of the drum [20], a system that reduces the pressure inside the drum [20] so that a pressure drop is established across the membrane [50], thereby causing separation of the feed stream into a first permeate stream that contains penetrants, which pass through the membrane [50] and drum wall [30], and a residue [60] that accumulates on the surface of the membrane [50], wherein the pressure drop across the membrane [50] is maintained below the bubble point of the membrane [50], so that liquid will pass through the membrane, but gas will not.

### TECHNICAL FIELD

This invention involves a system for filtering and thereby separating compounds that are mixed in a liquid.

### BACKGROUND ART

Rotary drum filters have been used for filtering and thereby separating compounds that are mixed in a liquid.

As shown in FIG. 1, a prior art rotary vacuum filter drum consists of a perforated drum rotating axially in a tub of liquid to be filtered. The technique is well suited to high-solids liquids that would blind or block other forms of filter. The drum is pre-coated with a filter aid, typically of diatomaceous earth (DE) or Perlite. After the pre-coat has been applied to the porous cylindrical surface of the drum, the liquid to be filtered is sent to the tub below the drum. The drum rotates through liquid and the vacuum inside of the drum sucks liquid and solids onto the drum pre-coat surface, the liquid portion is sucked by the vacuum through the filter media to the internal portion of the drum, and the filtrate (liquid) is pumped away. The solids adhered to the outside of the pre-coat, which then passes a knife, that cuts off the solids and a small portion of the filter media to reveal a fresh media surface that will enter the liquid as the drum rotates. The knife axially advances automatically as the surfaces removed until all of the pre-coat is removed.

We are aware of the following publications. Wait U.S. Pat. No. 1,512,321, Siebenthal U.S. Pat. No. 2,812,064, Kuestler, et al. U.S. Pat. No. 2,947,668, Kroff U.S. Pat. No. 3,113,926, Hirs (I) U.S. Pat. No. 3,168,471, Arnold, et al. U.S. Pat. No. 3,372,811, Light U.S. Pat. No. 3,780,863, Hirs (II) U.S. Pat. No. 4,826,596, Krettek U.S. Pat. No. 5,091,084, Cobb et al. U.S. Pat. No. 5,098,583, Hirs (III) U.S. Pat. No. 5,112,485, Ginn et al (I) U.S. Pat. No. 5,213,687, Ginn et al. (II) U.S. Pat. No. 5,223,155, Ginn et al. (III) U.S. Pat. No. 5,545,338, Ginn et al. (IV) U.S. Pat. No. 5,547,574, Wroblewski et al. U.S. Pat. No. 6,106,897, A ndresen et al. U.S. Pat. No. 6,174,446, Kossik, et al. U.S. Pat. No. 6,336,561, Hirs (IV) U.S. Pat. No. 6,358,406, Lee, et al. U.S. Pat. No. 6,500,344, Rupp U.S. Pat. No. 7,662,279, Hornbostel U.S. Pat. No. RE 24,430, Makinen, et al. US Pat Ap. 007/0144957, and Ekberg et al. US Pat Ap. 2011/0031193.

There are situations, however, where they can be inefficient and/or generally ineffective.

These and other difficulties experienced with the prior art devices have been obviated in a novel manner by the present invention.

It is, therefore, an outstanding object of some embodiments of the present invention to provide a rotary drum filter that provides enhanced capabilities and efficiencies in its use.

With these and other objects in view, as will be apparent to those skilled in the art, the invention resides in the combination of parts set forth in the specification and covered by the claims appended hereto, it being understood that changes in the precise embodiment of the invention herein disclosed may be made within the scope of what is claimed without departing from the spirit of the invention.

### BRIEF SUMMARY OF THE INVENTION

A system for separating a penetrant from a feed steam, using a drum filter, which includes a drum with a porous cylindrical drum wall, a tank in which the drum is rotatably mounted, a feed stream, a semipermeable membrane on the outside surface of the drum, a vacuum system that reduces the pressure inside the drum so that a pressure drop is established across the membrane, thereby causing separation of the feed stream into a first permeate stream that contains penetrants, which pass through the membrane and drum wall, and a residue body that accumulates on the outside surface of the membrane, wherein the pressure inside the drum is reduced so that the pressure drop across the membrane is below the bubble point of the membrane, so that liquid will pass through the membrane, but gas will not.

The vacuum drum filter, comprises a drum, that, in turn, has a porous cylindrical drum wall, a tank in which the drum is rotatable mounted, a feed stream that is directed to the outside of the drum and into the tank, a semipermeable membrane on the outside surface of the drum, a vacuum system that reduces the pressure inside the drum so that a pressure drop is established across the membrane, thereby causing separation of the feed stream into a first permeate stream that contains penetrants, both of which pass through the membrane and drum wall, a second retentate stream, that does not pass through the drum wall, and a third residue body that was contained in the feed stream but does not pass through the drum surface, and causing the residue from the retentate stream to accumulate on the outside surface of the membrane.

In some embodiments of the filter, it is operated so that the pressure inside the drum is reduced so that the pressure drop across the membrane is below the bubble point of the membrane, so that liquid will pass through the membrane, but gas will not.

In some embodiments of the filter, the membrane is continuously feed to the drum surface.

In some embodiments of the filter, the membrane is continuously feed from a source to the drum surface.

In some embodiments of the filter, the membrane is continuously feed from a cleaning station to the drum surface.

In some embodiments of the filter, the membrane is continuously striped from the drum surface.

In some embodiments of the filter, the membrane is continuously striped from the drum surface and fed to a collection device.

In some embodiments of the filter, the membrane is continuously striped from the drum surface and fed to a cleaning station at which the residue is removed from the membrane.

In some embodiments of the filter, the membrane is continuously striped from the drum surface and fed to a cleaning station at which the residue is removed from the membrane, after which the membrane is continuously fed to the drum surface.

In some embodiments of the filter, the membrane comprises an outer membrane that has an outer surface, and that covers at least a covered portion of the drum surface, and does not allow residue to pass through it into the drum, so that the residue accumulates on the outer surface of the outer membrane, and a middle membrane inside of the outer membrane, and that covers the entire drum surface and is maintained at a pressure drop below is bubble point, so that liquid can pass though it, but gas cannot, so that it maintains the vacuum in the drum,

In some embodiments of the filter, there is an uncovered portion of the drum surface that is not covered by the outer membrane, and that uncovered portion is covered by the middle membrane and thereby sealed against gas intrusion.

The invention might also be viewed as a novel method, using a vacuum drum filter that has a drum, that, in turn, has a porous cylindrical drum wall, and a tank in which the drum is rotatable mounted, and that drum filter accepts a feed stream directed to the drum, separates the feed stream into a first permeate stream that contains penetrants, both of which pass through the drum wall, a second retentate stream, that does not pass through the drum wall, and a third residue body that was contained in the feed stream but does not pass through the drum surface, said drum filter comprising placing a semipermeable membrane on the outside surface of the drum, placing the feed stream into the tank, reducing the pressure inside the drum so that a pressure drop is established across the membrane, causing the permeate stream and at least some of the penetrants to pass through the membrane and into the drum, and causing the residue from the retentate stream to accumulate on the outside surface of the membrane.

In some embodiments of the method, the pressure inside the drum is reduced so that the pressure drop across the membrane is below the bubble point of the membrane, so that liquid will pass through the membrane, but gas will not.

In some embodiments of the method, the membrane is continuously feed to the drum surface.

In some embodiments of the method, the membrane is continuously feed from a source to the drum surface.

In some embodiments of the method, the membrane is continuously feed from a cleaning station to the drum surface.

In some embodiments of the method, the membrane is continuously striped from the drum surface.

In some embodiments of the method, the membrane is continuously striped from the drum surface and fed to a collection device.

In some embodiments of the method, the membrane is continuously striped from the drum surface and fed to a cleaning station at which the residue is removed from the membrane.

In some embodiments of the method, the membrane is continuously striped from the drum surface and fed to a cleaning station at which the residue is removed from the membrane, after which the membrane is continuously fed to the drum surface.

In some embodiments of the method, the membrane comprises an outer membrane that has an outer surface, and that covers at least a covered portion of the drum surface, and does not allow residue to pass through it into the drum, so that the residue accumulates on the outer surface of the outer membrane, and a middle membrane inside of the outer membrane, and that covers the entire drum surface and is maintained at a pressure drop below is bubble point, so that liquid can pass though it, but gas cannot, so that it maintains the vacuum in the drum,

In some embodiments of the method, there is an uncovered portion of the drum surface that is not covered by the outer membrane, and that uncovered portion is covered by the middle membrane and thereby sealed against gas intrusion.

### BRIEF DESCRIPTION OF THE SEVERAL VIEWS OF THE DRAWING

The character of the invention, however, may best be understood by reference to one of its structural forms, as illustrated by the accompanying drawings, in which:

FIG. 1 shows a prior art rotary vacuum filter drum consisting of a perforated drum rotating axially in a tub of liquid to be filtered,

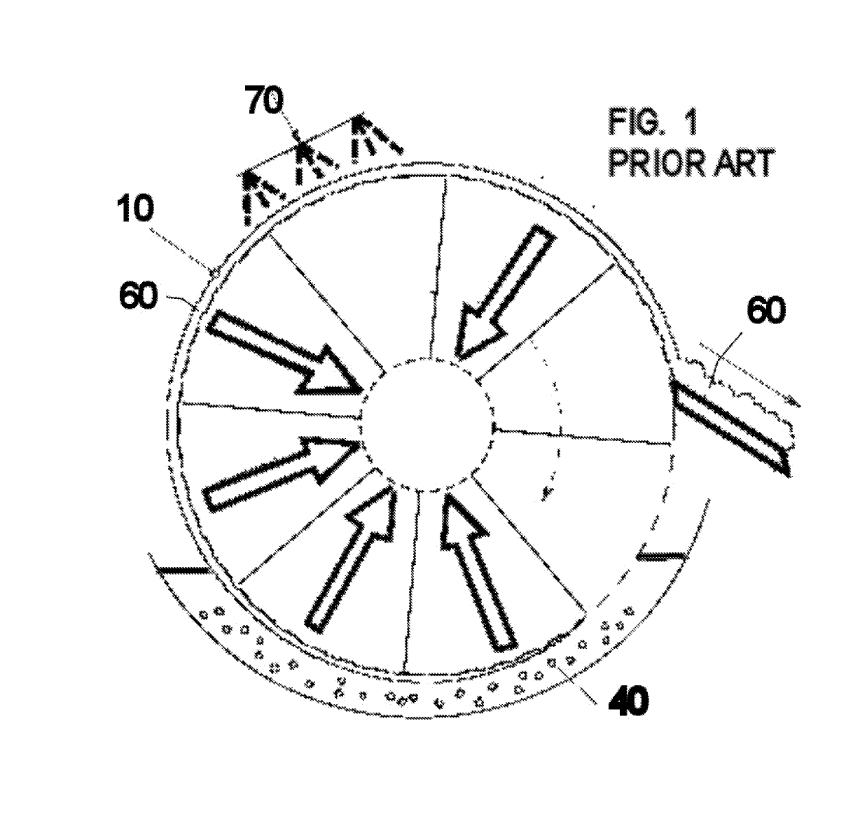

FIG. 2 shows an embodiment of a drum filter embodying some of the principles of the present invention and is shown with a membrane sheet replacing the pre-coat,

FIG. 3 shows a variation of the concept, in which the membrane is continuously fed on to the drum from a roll and then continuously rewound onto a take-up roll,

FIG. 4 shows a further variation of the concept, in which the membrane is continuously fed on to the drum from a roll and then continuously rewound onto a take-up roll,

FIG. 5 shows a portion of the drum surface, covered with the separation membrane on its outside surface and a sealing membrane between the separation membrane and the drum surface,

FIG. 6 shows another variation in which the continuous web is passes through a remote cleaning bath before it is returned to the drum,

FIG. 7 shows still another variation in which the continuous membrane web 51 passes from the drum 20, through a remote cleaning bath 95, and then back to the drum 20,

FIG. 8 shows a close-up view of the embodiment shown in FIG. 7,

FIG. 9 shows a geometry in which the filtering membrane 50 also functions as the sealing membrane, that is, the pressure drop across the filtering membrane 50 is maintained below the bubble point of the filtering membrane 50,

FIG. 10 shows a geometry in which the filtering membrane 50 is outside of the separate sealing membrane 55, and

FIG. 11 shows a special geometry in which the filtering membrane 50 is outside of the separate sealing membrane 55, but the filtering membrane 50 is temporarily separated from the sealing membrane 55 over a segment of the drum 20

### DETAILED DESCRIPTION OF THE INVENTION

This invention involves a rotary vacuum drum filter system in which the pre-coat is replaced by a sheet of finely porous membrane material. The membrane acts as a filter allowing the liquid to pass through the drum surface and into the drum, but not allowing suspended solids to pass through the drum surface and into the drum. The solids accumulate on the outer surface of the membrane, If the solids have value, they can be removed from the membrane. If the solids have no value, they can be disposed of with the membrane.

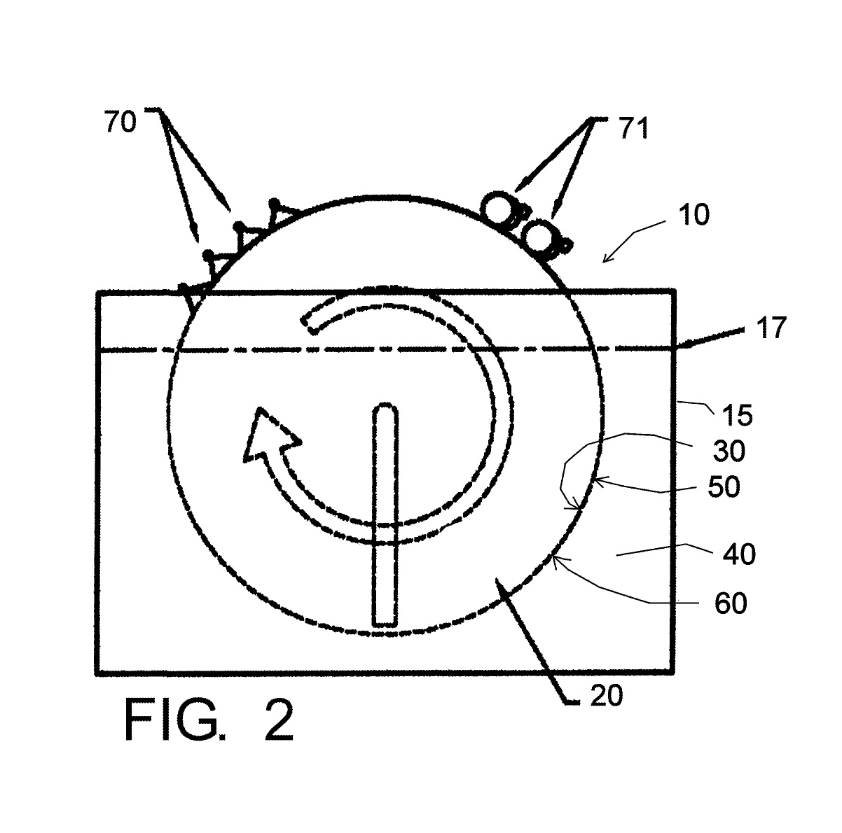

Referring to FIG. 2, the drum filter 10 is shown with a membrane sheet 50 replacing the pre-coat on the outer surface 30 of the porous drum 20. The drum 20 and membrane 50 are rotated through the liquid 40 in a tank 15 and the solids 60 accumulate on the outer surface 52 of the membrane 50. As the drum 20 rotates clock-wise out of the liquid 40, the solids 60 are sprayed by sprayers 70 and, subsequently, washers 71 remove the solids 60 from the membrane 50. The solids 60 are subsequently recovered or disposed of.

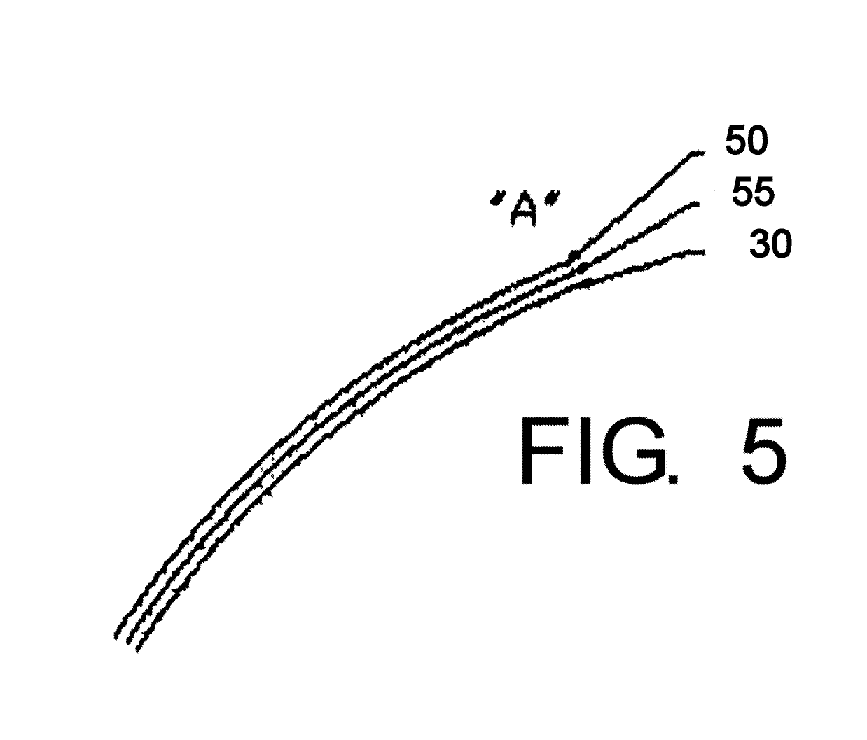

FIG. 5 shows a portion of the drum surface 30, covered with the separation membrane 50 on its outside surface. In the preferred embodiment, a vacuum seal membrane 55 is positioned between the drum surface 30 and the separation membrane 50, to minimize liquid flow under and around the edges of the separation membrane 50. This liquid flow under and around the edges of the separation membrane would allow solids to undesirably pass the filter membrane 50 and enter the drum. The membrane can be continuously reused. The vacuum seal membrane 55 can also have other important functions discussed below.

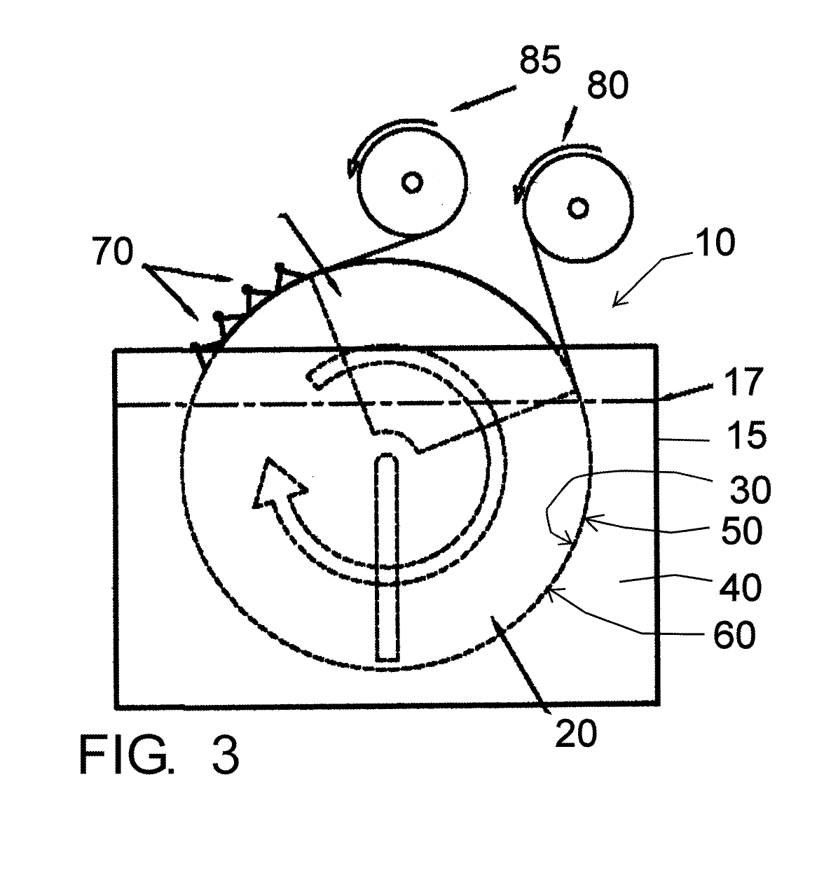

FIG. 3 shows a variation of the concept, in which the membrane 50 is continuously fed on to the drum 20 from a source roll 80 and then continuously rewound onto a take-up roll 85.

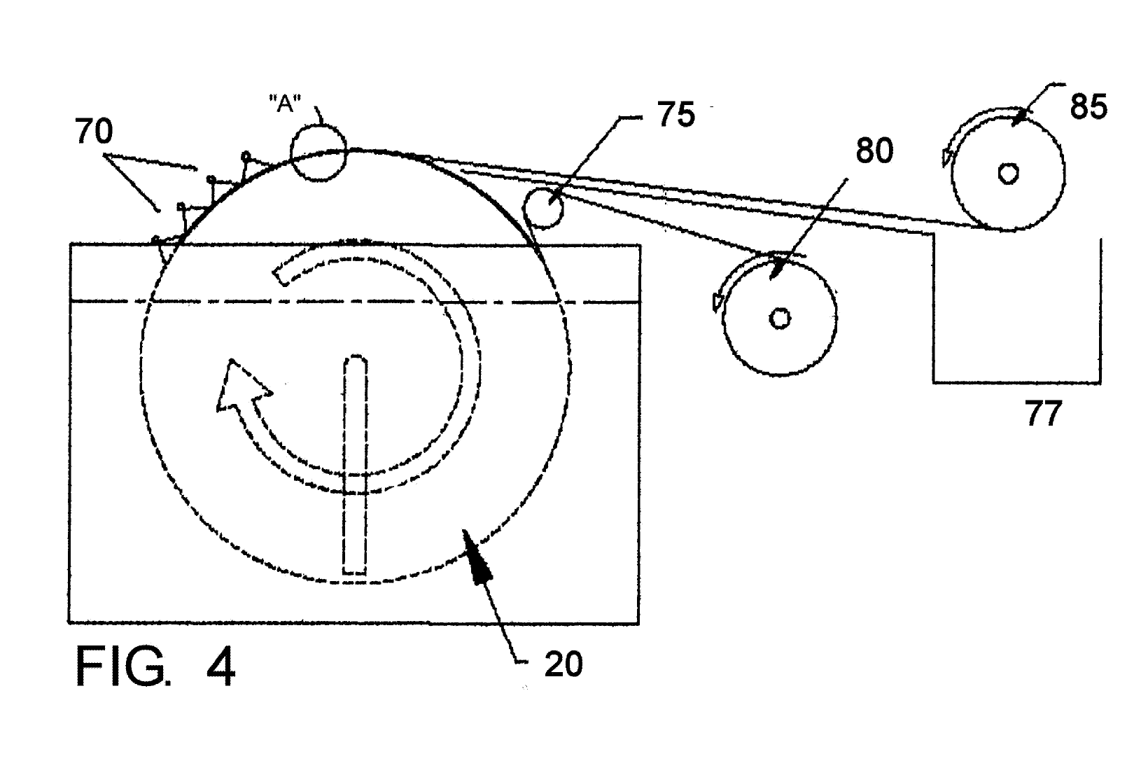

FIG. 4 shows a further variation of the concept, in which the membrane 50 is continuously fed on to the drum 20 from a source roll 80 and then continuously rewound onto a take-up roll 85. The take-up roller 85 is offset from the drum 20 and positioned over a waste tray 90 so that the solids can drain from the take-up roller 85.

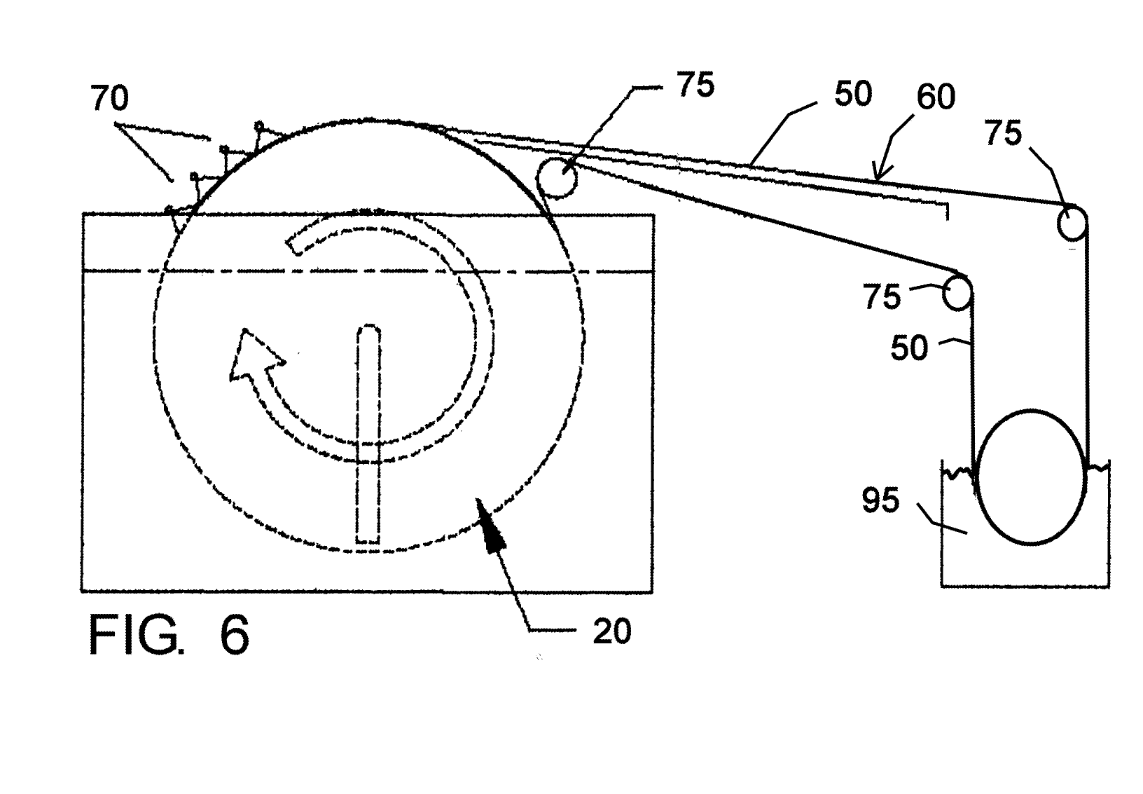

FIG. 6 shows another variation in which the continuous membrane web 51 passes from the drum 20, through a remote cleaning bath 95, and then back to the drum 20.

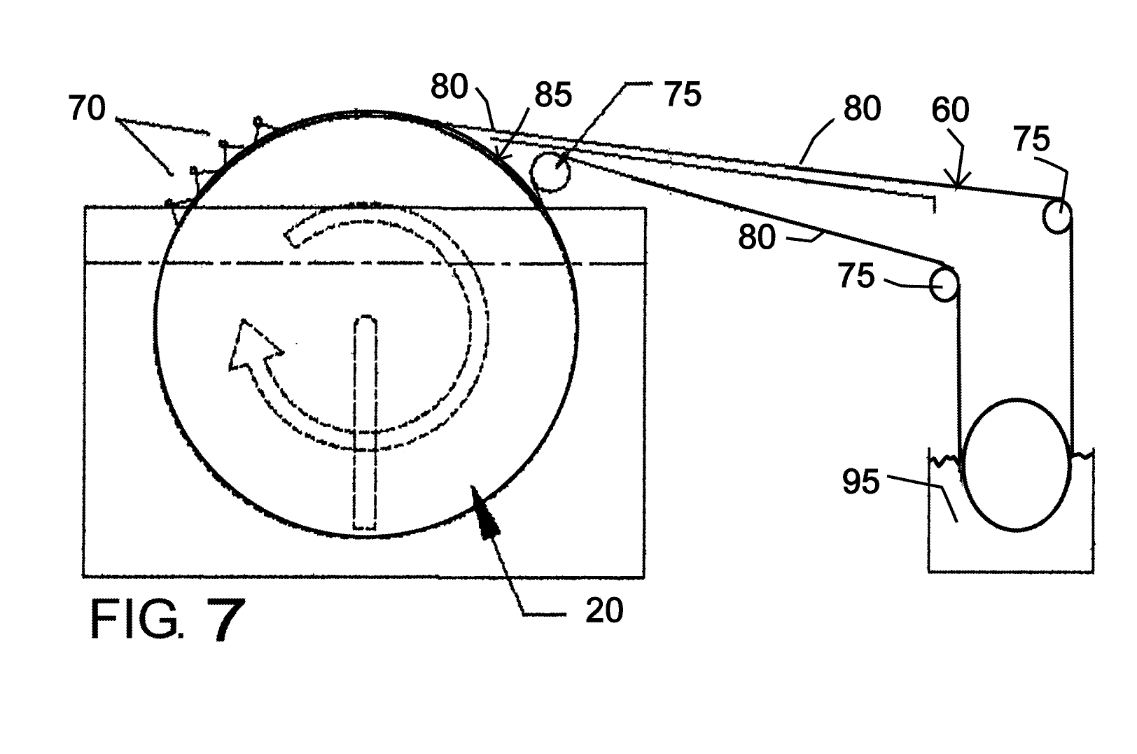

FIG. 7 shows still another variation in which the continuous membrane web 51 passes from the drum 20, through a remote cleaning bath 95, and then back to the drum 20. However, a middle or sealing layer 55 is present and continuously and completely covers the outer surface 30 of the drum 20.

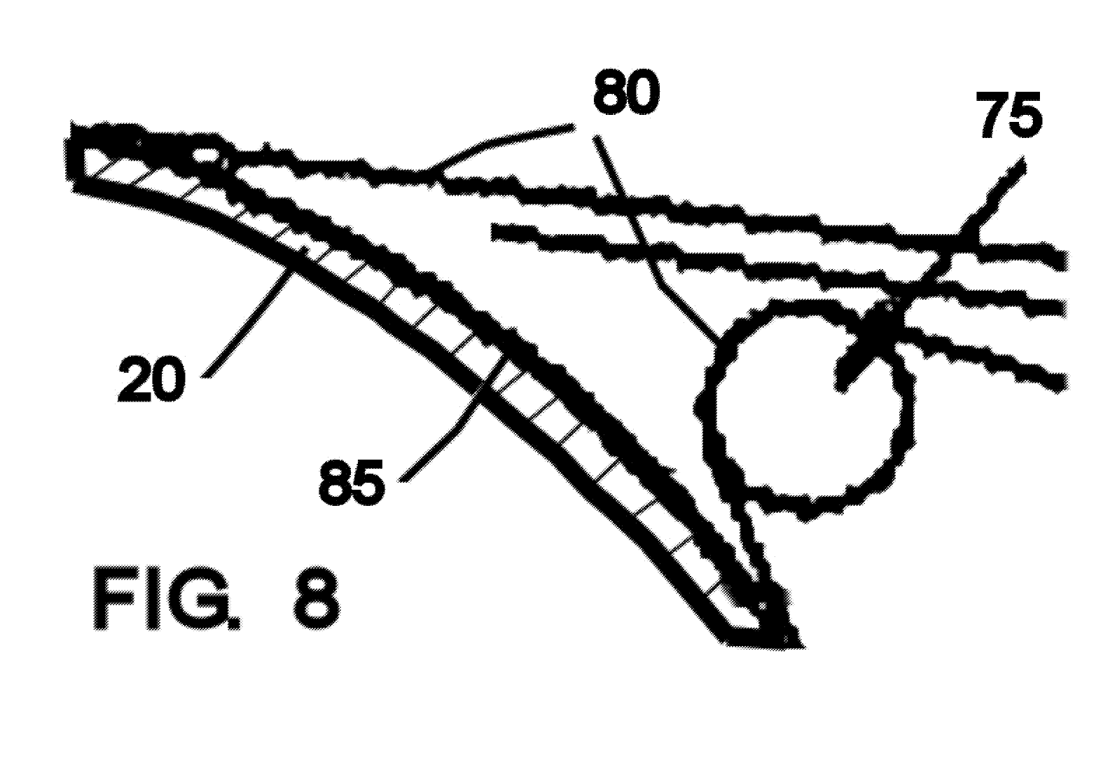

FIG. 8 shows a close-up view of the embodiment shown in FIG. 7, showing where the continuous membrane web 51 passes from the drum 20, and then recontacts the drum 20, leaving a uncovered segment 100 of the drum 20 that is not covered by the outer membrane 51. However, a middle or sealing layer 55 is present and continuously and completely covers this segment 100 of the drum 20. The middle or sealing layer 55 also can continuously and completely gas seal this segment 100 of the drum 20, as discussed below.

A very useful physical phenomena in this application of membrane filtering is the concept of the bubble. The bubble point of a membrane-liquid filtering situation is the pressure drop across the membrane at which bubbles of gas first appear. When the pressure drop across the membrane is below the bubble point, liquid can pass through the membrane but gases cannot. In the context of this invention, and the point of the vacuum within the drum is to draw liquids through the membrane with the liquids carrying the components in the liquids that can pass through the membrane. Any gas that passes through the membrane simply adds to the workload of the vacuum pump that is evacuating the drum and increases the cost of operating the filter from system. By controlling the vacuum within the vacuum drum so that the pressure drop across the filtering membranes is consistently below the bubble point, the cost of operating the system can be substantially reduced, as compared to normal filtering.

There are generally three geometries of membranes that are relevant to this situation.

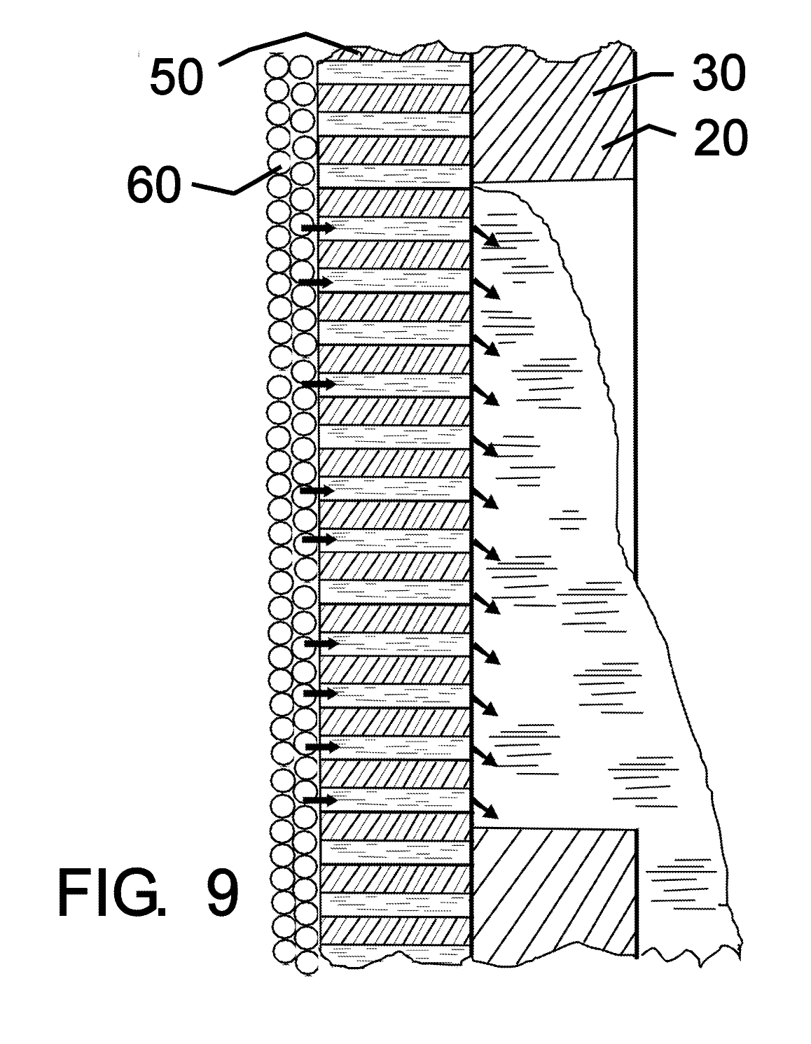

FIG. 9 shows a geometry in which the filtering membrane 50 also functions as the sealing membrane, that is, the pressure drop across the filtering membrane 50 is maintained below the bubble point of the filtering membrane 50. As shown in FIG. 9, the liquid passes through the filtering membrane 50, then the through the porous surface 30 of the drum 20, and into the drum 20. The solids 60 that cannot pass through the filtering membrane 50 accumulate on the outer surface of the filtering membrane. Because the pressure drop across the filtering membrane 50 is below the bubble point of the filtering membrane 50, gas does not pass through the filtering membrane 50 into the drum 20. Thus the work required to maintain the vacuum is less than would other wise be the case.

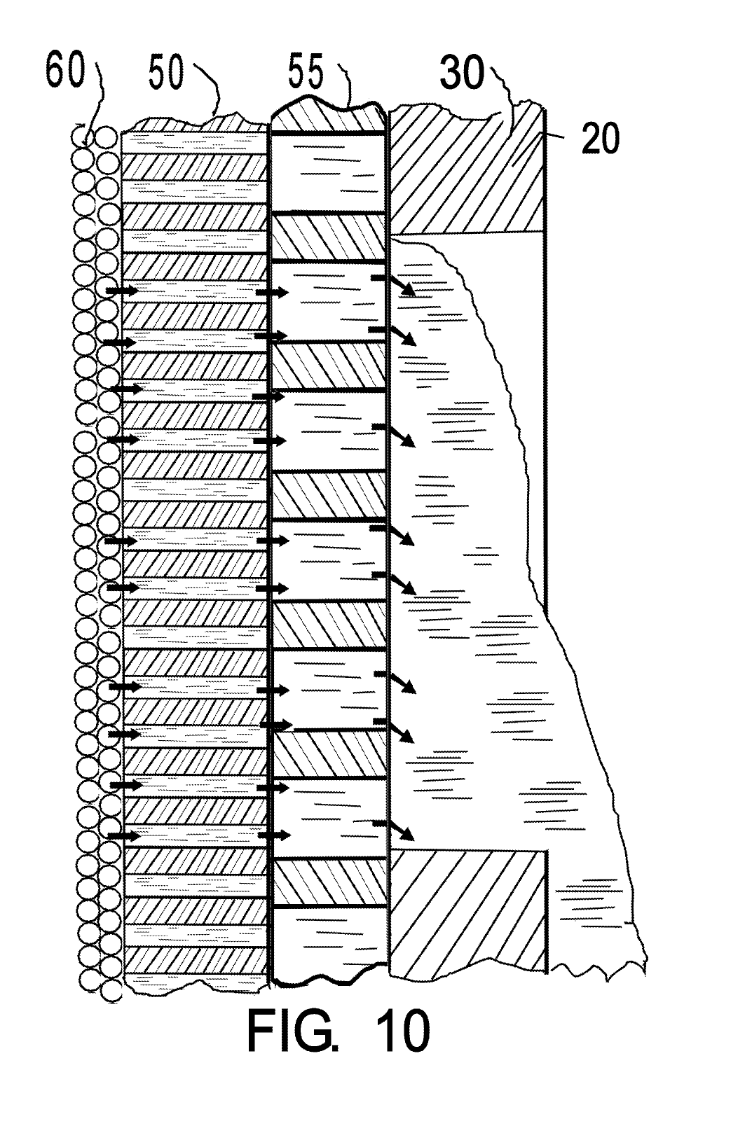

FIG. 10 shows a geometry in which the filtering membrane 50 is outside of the separate sealing membrane 55. The pressure drop across the sealing membrane 55 is maintained below the bubble point of the sealing membrane 55. As shown in FIG. 10, the liquid passes through the filtering membrane 50, then through the sealing membrane 55, then the through the porous surface 30 of the drum 20, and into the drum 20. The solids 60 that cannot pass through the filtering membrane 50 accumulate on the outer surface of the filtering membrane 50. Because the pressure drop across the sealing membrane 55 is below the bubble point of the sealing membrane 55, gas does not pass through the sealing membrane 55 into the drum 20. Thus the work required to maintain the vacuum is less than would other wise be the case.

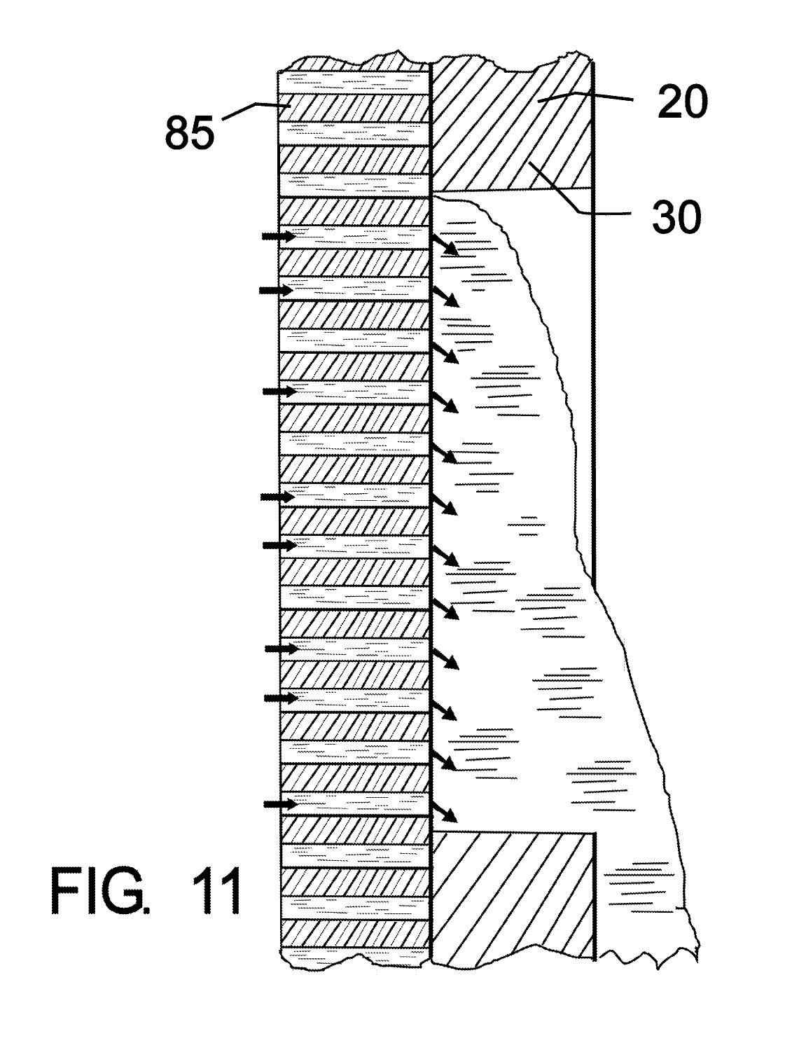

FIG. 11 shows a special geometry in which the filtering membrane 50 is outside of the separate sealing membrane 55, but the filtering membrane 50 is temporarily separated from the sealing membrane 55 over a segment of the drum 20, thus leaving the sealing membrane 55 uncovered temporarily. The pressure drop across the uncovered sealing membrane 55 is maintained below the bubble point of the sealing membrane 55. As shown in FIG. 11, the liquid passes through the sealing membrane 55, then the through the porous surface 30 of the drum 20, and into the drum 20. This geometry is generally used when the uncovered sealing layer 55 is above the level of the to-be-filtered liquid, so that there are no solids 60 that can accumulate on the outer surface of the sealing membrane 55 or otherwise pass through the sealing membrane 55. Because the pressure drop across the sealing membrane 55 and is below the bubble point of the sealing membrane 55, gas does not pass through the sealing membrane 55 into the drum 20, even though the sealing membrane 55 is not covered, over that drum segment, by the filter layer 50. Thus the work required to maintain the vacuum is less than would other wise be the case. This geometry is particularly useful in designs in which the filter layer 50 is lifted from the drum and then replaced such as the embodiments in FIGS. 3, 4, 6, 7, and 8.

### Membrane/Rotary Vacuum Liquid Filtration Process and Equipment

### Process Description

Using a conventional rotary vacuum filter assembly replace the filter screen and filter cake with semi-permeable asymmetric membrane. The membrane skin is on the outside of the drum. Wet the membrane with solvent, typically water. Apply vacuum to the inside of the drum. Rotate the drum. Submerge a portion of the drum in the liquid to be filtered. The motive force of the pressure across the semi-permeable membrane will cause the solvent to flow through the membrane. Particles either suspended or dissolved in the liquid that will not pass through the membrane will be deposited on the surface of the membrane. These particles are analogous to the “cake” on a conventional rotary vacuum filter. As the drum rotates, these particles will be rotated out of the liquid.

Once the particles deposited on the membrane surface have rotated out of the liquid, the particles and membrane structure can be diafiltered or washed by spraying the surface of the drum where the particles have been deposited with clean solvent. This passes valuable dissolved constituents through the membrane to be recovered.

The membrane is then cleaned of these particles before it re-enters the liquid. The cleaning is carried out by physically wiping the surface of the membrane. This is accomplished with a mechanical wiper or sponge. This device may be stationary or may move to improve cleaning or expose fresh wiper to the membrane surface. The mechanical methods of cleaning can be replaced or combined with chemical methods of cleaning if the mechanical cleaning is not successful or needs to be improved. If chemical means are used, the chemical liquid may be pulled through the membrane by the internal vacuum on the drum. Steps may be taken to isolate the chemical cleaner from the process liquid by segmenting the drum internally to either remove vacuum from a portion of the drum or to collect the chemical cleaner separately. The chemical cleaning may be followed by a spray wash as described above to remove cleaner from the membrane.

The morphology and chemistry of the membrane used can be tailored to the process. Membrane media can be hydrophilic, hydrophobic, charged positively or negatively, uncharged, constructed of many different materials, vary in pore size, wetting angle, zeta potential, and other parameters all of which may affect the performance of the device. Membrane selection and cleaning method must be tailored to fit the process.

Using a hydrophilic membrane with a bubble point above atmospheric pressure will greatly reduce the volumetric requirement for the vacuum pump. This is because water flow through the membrane easily once it has been wetted and the membrane will not allow passage of air in the wetted condition at tranmembrane pressure below the bubble point.

All of the parameters listed above can affect the performance of the device. The quality of the separation will be determined primarily by the pore size of the membrane used but also affected by the other characteristics of the membrane along with the amount of pressure applied across the membrane. The productivity of the device will likewise be affected by the same parameters.

Among the benefits of this invention are high capacity for solids removal, precise separation, continuous operation, and no filter aid requirement. The no filter aid requirement benefits includes no filter rate expense, no filter rate health and safety issues, no introduction of foreign material from the filter rate into the process, and no filter rate disposal problems. Additional benefits include the many variations of semi-permeable membrane available from many manufacturers, and low cost membrane media due to competition among suppliers. Another benefit is the low energy requirement especially when bubble point of membrane is above transmembrane pressure applied, since, when the pressure drop across the membrane is below the bubble point, the membrane passes liquids, but does not pass gas, so vacuum pump work is reduced. For the benefits include wide applicability across many processes, no batch to batch contamination, a sufficiently cleanable, sanitizable, and sterilizable system. Furthermore, the system has a small labor requirement, can be fully automated, has a very low speed and low maintenance operation, low shear on the product, and very little temperature effect.

Some of the variations in the system include continuous membrane replacement while processing (no cleaning), belt configuration, non-membrane filter media, improved cleaning process, inside-out operation, and bath circulation to improve productivity (tangential flow).

A significant benefit to some embodiments os this invention device is the device's ability to remove material without concentrating the feed solution or suspension.

With other “flow through” filtration media, the feed solution or suspension is pumped through the filter media. As the rejected species build up on the surface of the filter, the flow of fluid and non-rejected species is reduced, often dramatically. This blinding of the filter media is a characteristic of conventional filter media, With tangential flow or “crossflow” filter media, often seen with microfiltration and ultrafiltration media, the feed solution or suspension is concentrated while being circulated around a piping loop. Included in this loop is the filter media. A small fraction of the recirculated volume is removed as filtrate or permeate. Maintaining high velocity across the membrane surface helps reduce the effect of feed concentration. As the concentration increases, the productivity of the filter is reduced. The relationship between feed concentration and filter productivity is well understood and is considered in the design of conventional tangential flow equipment. Allowance for this characteristic requires increased membrane area and increases the size and cost of the equipment in general.

This device does not concentrate the feed suspension or solution. Since the rejected species are removed from the liquid stream, the feed is always at initial concentration. This characteristic is a novel feature of this device. It has the effect of “lifting” the rejected species from the feed solution or suspension with further concentration. This will enhance the productivity of the filter media and allows for separation of highly concentrated feed streams.

Conventional semi-permeable membrane separations use tangential flow filtration (TFF) methodology to enhance membrane productivity. In TFF, the bulk stream is passed at high velocity across the membrane surface (the tangential part) under pressure. A small portion of the bulk stream passes through the membrane as permeate. This results in a concentration of the rejected species at the membrane surface. If the tangential velocity is not high enough, this concentrated layer will reduce the amount of permeate that can pass through the membrane. This is known as “concentration polarization” of the membrane. The layer deposited is known as the “gel layer”. By maintaining high tangential velocity, the rejected species are swept back into the bulk stream and an equilibrium is reached where the gel layer does not increase if the concentration of rejected species does not increase. This results in relatively stable permeation rates over long periods of time compared to standard through flow filtration. To take advantage of TFF, the filtration media must be an asymmetric membrane, where the active surface has the fine pores used for the separation and the supporting membrane structure is very much coarser and more open. With this morphology, the underlying membrane structure is not plugged because particles that pass through the active surface pass easily through the support structure.

Since high velocities are required to keep the productivity of the membrane stable, large pumps with large motors are employed. The bulk fluid is circulated from a tank, across the membrane (where a small percentage is removed as permeate) and returned to the tank. The volume of feed stock in the tank is reduced as permeate is removed from the system. Since the mass of the rejected species remains constant and the volume of the feed stream is reduced, the concentration of the rejected species in the feed stream is increased.

The increasing concentration of the rejected species reduces the rate at which permeate can pass through the membrane since the equilibrium at the membrane surface shifts, causing more concentration polarization and increasing the gel layer.

This ultimately limits the process to some upper limit of rejected species concentration, based on membrane productivity and the pumpability of the feed stream.

With the proposed device, the rejected species are lifted from the feed stream. Since fresh feed at initial concentration is pumped into the feed sump, and the rejected species are captured from the fluid and removed from the system, the feed stream is not concentrated. The rejected species are removed and used or disposed elsewhere.

The makes the device able to operate at very high concentrations of rejected species and allows for complete separation of rejected material and carrier solvent without the use of large pumps and a lot of energy.

Conventional TFF equipment concentrates rejected species in the feed stream. The proposed equipment removes rejected from the feed stream.

### Membrane Vacuum Device: Vacuum Control Using Wet Membrane Gas Permeability.

A characteristic of semi-permeable membrane is the ability to permeate solvent and not air once wetted with solvent. Applying gas pressure across a wetted membrane will not displace the liquid from the pore structure of the membrane below the “bubble point” pressure of the membrane. The bubble point pressure is that pressure at which the liquid is displaced from the pore structure and gas then freely flows. The pressure required to displace the liquid is determined by the pore diameter, material of construction and other characteristics of the membrane coupled with the surface tension, viscosity and other characteristics of the fluid. The bubble point of a particular membrane/solvent can be determined mathematically or empirically. In practice, applying increasing gas pressure across a wetted membrane will displace the fluid completely at a specific pressure and gas will flow through the membrane freely once the fluid has been displaced. This technique is used to characterize membrane material. Pores which are significantly larger than the average pore will emit a stream of bubbles that can be seen co at a lower pressure than the bubble point pressure. Membrane material with a very narrow pore size distribution will show a nearly complete displacement of liquid from the pores at a specific pressure. The pressure at which the fluid is displaced is indicative of the average pore diameter for that specific membrane/liquid system.

The device exploits this characteristic. Wrapping a coarsely porous drum with membrane material, wetting the membrane and applying pressure across the membrane will force liquid through the membrane without allow gas to flow through the membrane. By using vacuum inside the drum to force the liquid through the membrane, and using a membrane/liquid system that where the bubble point pressure of the membrane is greater than one atmosphere, the wetted membrane acts as a vacuum seal and reduces the energy required to power a vacuum pump. As long as the membrane is kept wetted, gas will not flow through the membrane but liquid will. Particles that will not pass through the membrane will be collected on the membrane surface or inside the pore structure of the membrane.

In an application where the membrane is not cleaned but rather is refreshed by continuous replacement, vacuum will be lost inside the drum where the membrane is not in contact with the drum. To maintain vacuum, the drum is wrapped fully around the circumference (ends of drum are solid) with membrane that has a bubble point pressure above the pressure developed across the membrane by the vacuum. This assembly is then partially wrapped with another layer a membrane, fed from a spool of membrane and taken up by another spool. This outer membrane will be of finer porosity than the underlying layer of membrane and do the separation required. The outer layer will keep particles from plugging the pore structure of the underlying membrane. The liquid permeability of the inner layer should be greater than the outer layer by a significant margin. In this way, the majority of the pressure used to drive the separation is dropped across the finer, outer membrane layer and little pressure drop is lost across the inner layer.

Membrane/Vacuum Process Description: The process removes dissolved or suspended solids from a liquid using a semi-permeable membrane. The solids are removed without pumping the fluid through the filtering membrane. The solids are lifted out of the solution or suspension without necessarily concentrating the solution or suspension. The solvent is drawn through the membrane using vacuum. The process uses characteristics of the membrane/solvent system to reduce complexity and save energy.

The primary separation device is a rotating rigid drum, mounted horizontally with the cylindrical surface of the drum having a porous or perforated surface. This may be wrapped with a screen to support an outer membrane layer and to allow filtrate to flow through the wall of the drum. The membrane is wrapped outside of any supporting layers, the filtering surface can be installed facing inward or outward.

The drum is partially submerged in the fluid to be separated. A vacuum is applied to the inside of the drum, drawing liquid through the membrane and the supporting wall of the drum. The separated material is deposited on the surface of the membrane. The drum is rotated continuously, lifting the deposited material out of the liquid while introducing cleaned or fresh membrane to the fluid. The deposited material is washed by spraying the exposed surface with clean solvent. The membrane is either cleaned by scraping or otherwise mechanically and/or chemically removing the deposited material or by removing the contaminated membrane from the system while introducing new (fresh) membrane to the system.

The system exploits a characteristic of the membrane known and the membrane bubblepoint. Many semi-permeable membranes exhibit this characteristic. This is characteristic is used by membrane manufacturers and users to assure that the membrane does not have holes or imperfections in it. Many semi-permeable membrane filters will allow gas (air) to flow through when dry. These same membranes will not allow any gas to flow through when wetted with solvent (often water). Gas will diffuse through the membrane at a slow rate but will not pass through the membrane as gas bubbles. If pores exist in the membrane that are larger than expected, bubbles will be seen passing through the membrane and the gas flowrate through the membrane will be high.

By wrapping the drum with wet membrane, air will not pass through and vacuum will be maintained. At the same time, liquid will flow through the membrane. This means the vacuum pump used is sized at the flowrate of the liquid passing through the membrane and energy is not wasted pulling air through the filter membrane.

By adding an additional membrane layer under the active filtering layer, vacuum can be maintained without segmenting the drum internally. The underlying membrane layer needs to be larger in pore size than the active filtering layer so material that passes through the active layer does not plug up the underlying layer. The underlying layer must have a bubble point pressure in the solvent greater than the pressure used to drive the liquid through the membranes. If the bubble point of the underlying layer is too low, the solvent will be pulled out of the pore structure of that layer and vacuum will be lost.

The underlying layer can be replaced with an internal drum segment where vacuum is precluded from the external cylindrical wall of the drum so the active membrane layer can be removed and refreshed.

Many semipermeable membranes are most porous before the membrane material has been exposed to pressure and/or heat. Pressure and/or heat can compact the membrane, greatly reducing the permeability of the membrane after a short period of time. This system can replace the membrane with fresh membrane continuously, so that the very high permeability of the non-compacted membrane is seen continuously. This enhances the productivity if the system.

Application of membrane Vacuum filter to remove high concentrations of suspended solids.

In the fermentation of mammalian cells, high cell density in the bioreactor is advantageous. It is advantageous because the concentration of the desired protein is also high. In recent years, cell density has increased to the point where removal of cells or cell debris has become problematic. The target protein is dissolved in the solvent (water) in which the cells and/or cell debris are suspended. The suspended material must be separated from the solvent in order to process the solvent. Solvent processing usually consists of purifying and concentrating the target protein by various filtration and separation steps, e.g. ultrafiltration, diafiltration, chromatography. It is not possible to do this purification and concentration with the suspended material present.

Various methods of removal of suspended solids have been employed. At low suspended solids (SS) concentrations, depth filtration using fiberous filters with high dirt holding capability has been used. These filter plug up too quickly to be viable with somewhat higher SS concentrations. At these higher SS concentrations, gravity separation by centrifugation has become the norm. These high speed machines do well for SS removal but are expensive to buy and operate. They do not perform well at very high SS concentrations.

A membrane vacuum filter that embodies some of the principles of the present invention will work well at these high concentrations. The cells and cell debris will be pulled onto the membrane by vacuum and remain there to be cleaned off or disposed with the membrane. Product recovery will be high if washing of the residue deposited on the filter surface is employed. It may be possible to pre-concentrate the cell mass in the bioreactor. The membrane vacuum filter will work well for this application. In general high density suspensions will be handled well using this device.

### INDUSTRIAL APPLICABILITY

This invention can be used whenever it is necessary to filter and thereby separate compounds that are mixed in a liquid.

While it will be apparent that the illustrated embodiments of the invention herein disclosed are calculated adequately to fulfill the object and advantages primarily stated, it is to be understood that the invention is susceptible to variation, modification, and change within the spirit and scope of the subjoined claims. It is obvious that minor changes may be made in the form and construction of the invention without departing from the material spirit thereof. It is not, however, desired to confine the invention to the exact form herein shown and described, but it is desired to include all such as properly come within the scope claimed.

The invention having been thus described, what is claimed as new and desire to secure by Letters Patent is:

What I claim as my invention is:

1. A vacuum drum filter, comprising:
a. a drum, that, in turn, has a porous cylindrical drum wall,
b. a tank in which the drum is rotatable mounted,
c. a feed stream that is directed to the outside of the drum and into the tank,
d. a semipermeable membrane on the outside surface of the drum,
e. a vacuum system that reduces the pressure inside the drum so that a pressure drop is established across the membrane, thereby causing separation of the feed stream into a first permeate stream that contains penetrants, both of which pass through the membrane and drum wall, a second retentate stream, that does not pass through the drum wall, and a third residue body that was contained in the feed stream but does not pass through the drum surface, and causing the residue from the retentate stream to accumulate on the outside surface of the membrane.

2. A drum filter as recited in claim 1, where the pressure inside the drum is reduced so that the pressure drop across the membrane is below the bubble point of the membrane, so that liquid will pass through the membrane, but gas will not.

3. A drum filter as recited in claim 1, wherein the membrane is continuously feed to the drum surface.

4. A drum filter as recited in claim 1, wherein the membrane is continuously feed from a source to the drum surface.

5. A drum filter as recited in claim 1, wherein the membrane is continuously feed from a cleaning station to the drum surface.

6. A drum filter as recited in claim 1, wherein the membrane is continuously striped from the drum surface.

7. A drum filter as recited in claim 1, wherein the membrane is continuously striped from the drum surface and fed to a collection device.

8. A drum filter as recited in claim 1, wherein the membrane is continuously striped from the drum surface and fed to a cleaning station at which the residue is removed from the membrane.

9. A drum filter as recited in claim 1, wherein the membrane is continuously striped from the drum surface and fed to a cleaning station at which the residue is removed from the membrane, after which the membrane is continuously fed to the drum surface.

10. A drum filter as recited in claim 1, wherein the membrane comprises an outer membrane that has an outer surface, and that covers at least a covered portion of the drum surface, and does not allow residue to pass through it into the drum, so that the residue accumulates on the outer surface of the outer membrane, and a middle membrane inside of the outer membrane, and that covers the entire drum surface and is maintained at a pressure drop below is bubble point, so that liquid can pass though it, but gas cannot, so that it maintains the vacuum in the drum,

11. A drum filter as recited in claim 10, wherein there is an uncovered portion of the drum surface that is not covered by the outer membrane, and that uncovered portion is covered by the middle membrane and thereby sealed against gas intrusion.

12. A vacuum drum filter, comprising:
a. a drum, that, in turn, has a porous cylindrical drum wall,
b. a tank in which the drum is rotatable mounted,
c. a feed stream that is directed to the outside of the drum and into the tank,
d. a semipermeable membrane on the outside surface of the drum,
e. a vacuum system that reduces the pressure inside the drum so that a pressure drop is established across the membrane, thereby causing separation of the feed stream into a first permeate stream that contains penetrants, both of which pass through the membrane and drum wall, a second retentate stream, that does not pass through the drum wall, and a third residue body that was contained in the feed stream but does not pass through the drum surface, and causing the residue from the retentate stream to accumulate on the outside surface of the membrane, wherein the pressure inside the drum is reduced so that the pressure drop across the membrane is below the bubble point of the membrane, so that liquid will pass through the membrane, but gas will not, and
wherein the membrane is continuously striped from the drum surface and fed to a cleaning station at which the residue is removed from the membrane, after which the membrane is continuously fed to the drum surface, and
wherein the membrane comprises an outer membrane that has an outer surface, and that covers at least a covered portion of the drum surface, and does not allow residue to pass through it into the drum, so that the residue accumulates on the outer surface of the outer membrane, and a middle membrane inside of the outer membrane, and that covers the entire drum surface and is maintained at a pressure drop below is bubble point, so that liquid can pass though it, but gas cannot, so that it maintains the vacuum in the drum, and
wherein there is an uncovered portion of the drum surface that is not covered by the outer membrane, and that uncovered portion is covered by the middle membrane and thereby sealed against gas intrusion.

13. A method of using a vacuum drum filter that has a drum, that, in turn, has a porous cylindrical drum wall, and a tank in which the drum is rotatable mounted, and that drum filter accepts a feed stream directed to the drum, separates the feed stream into a first permeate stream that contains penetrants, both of which pass through the drum wall, a second retentate stream, that does not pass through the drum wall, and a third residue body that was contained in the feed stream but does not pass through the drum surface, said drum filter comprising:
a. placing a semipermeable membrane on the outside surface of the drum,
b. placing the feed stream into the tank,
c. reducing the pressure inside the drum so that a pressure drop is established across the membrane,
d. causing the permeate stream and at least some of the penetrants to pass through the membrane and into the drum, and
e. causing the residue from the retentate stream to accumulate on the outside surface of the membrane.

14. A method as recited in claim 13, where the pressure inside the drum is reduced so that the pressure drop across the membrane is below the bubble point of the membrane, so that liquid will pass through the membrane, but gas will not.

15. A method as recited in claim 13, wherein the membrane is continuously feed to the drum surface.

16. A method as recited in claim 13, wherein the membrane is continuously feed from a source to the drum surface.

17. A method as recited in claim 13, wherein the membrane is continuously feed from a cleaning station to the drum surface.

18. A method as recited in claim 13, wherein the membrane is continuously striped from the drum surface.

19. A method as recited in claim 13, wherein the membrane is continuously striped from the drum surface and fed to a collection device.

20. A method as recited in claim 13, wherein the membrane is continuously striped from the drum surface and fed to a cleaning station at which the residue is removed from the membrane.

21. A method as recited in claim 13, wherein the membrane is continuously striped from the drum surface and fed to a cleaning station at which the residue is removed from the membrane, after which the membrane is continuously fed to the drum surface.

22. A method as recited in claim 13, wherein the membrane comprises an outer membrane that has an outer surface, and that covers at least a covered portion of the drum surface, and does not allow residue to pass through it into the drum, so that the residue accumulates on the outer surface of the outer membrane, and a middle membrane inside of the outer membrane, and that covers the entire drum surface and is maintained at a pressure drop below is bubble point, so that liquid can pass though it, but gas cannot, so that it maintains the vacuum in the drum,

23. A method as recited in claim 22, wherein there is an uncovered portion of the drum surface that is not covered by the outer membrane, and that uncovered portion is covered by the middle membrane and thereby sealed against gas intrusion.

24. A method of using a vacuum drum filter that has a drum, that, in turn, has a porous cylindrical drum wall, and a tank in which the drum is rotatable mounted, and that drum filter accepts a feed stream directed to the drum, separates the feed stream into a first permeate stream that contains penetrants, both of which pass through the drum wall, a second retentate stream, that does not pass through the drum wall, and a third residue body that was contained in the feed stream but does not pass through the drum surface, said drum filter comprising:
a. placing a semipermeable membrane on the outside surface of the drum,
b. placing the feed stream into the tank,
c. reducing the pressure inside the drum so that a pressure drop is established across the membrane,
d. causing the permeate stream and at least some of the penetrants to pass through the membrane and into the drum, and
e. causing the residue from the retentate stream to accumulate on the outside surface of the membrane,
wherein the pressure inside the drum is reduced so that the pressure drop across the membrane is below the bubble point of the membrane, so that liquid will pass through the membrane, but gas will not, and
wherein the membrane is continuously striped from the drum surface and fed to a cleaning station at which the residue is removed from the membrane, after which the membrane is continuously fed to the drum surface, and
wherein the membrane comprises an outer membrane that has an outer surface, and that covers at least a covered portion of the drum surface, and does not allow residue to pass through it into the drum, so that the residue accumulates on the outer surface of the outer membrane, and a middle membrane inside of the outer membrane, and that covers the entire drum surface and is maintained at a pressure drop below is bubble point, so that liquid can pass though it, but gas cannot, so that it maintains the vacuum in the drum, and
wherein there is an uncovered portion of the drum surface that is not covered by the outer membrane, and that uncovered portion is covered by the middle membrane and thereby sealed against gas intrusion.
